(19) United States
(12) Patent Application Publication
(10) Pub. No.: US 2004/0204928 A1
(43) Pub. Date: Oct. 14, 2004

(54) Simulator apparatus and related technology

(75) Inventor: Katsuya Shinohara, Osaka (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/814,306

(22) Filed: Apr. 1, 2004

(30) Foreign Application Priority Data
Apr. 9, 2003 (JP) P2003-104907

(51) Int. Cl. G06G 7/62

(52) U.S. Cl. 703/13

(57) ABSTRACT

A simulator apparatus comprises a simulator model including a functional model for CPU constituting a system to be simulated and a simulator model including a functional model for hardware to be connected to buses linked to the CPU. The respective simulator models include plural types of interfaces. The plural types of the interfaces enable plural types of simulators for different uses to access the functional models. The simulator apparatus further comprises a simulator controlling device for selecting any of the plural types of the interfaces and accessing the respective functional models via the selected interfaces.

### BACKGROUND OF THE INVENTION

This invention relates to a technology of simulation for the Large Scale Integrated Circuit (LSI), more particularly to an improvement of the technology for efficiently verifying hardware, software and system in the upstream design stage of the system-on-chip configuration.

In recent years, there has been an increasing demand for one-chip configuration, downsizing, weight saving, energy saving, and cost reduction for integrated circuits. This trend is particularly apparent in the field of digital IT household appliances. In response to this demand, the semiconductor chip manufactures have been shifting their focus on a system LSI.

Having a system divided into hardware and software so that the hardware and software are sequentially developed, lengthened time is required for the development. Therefore, the so-called “co-design”, in which the hardware and software are simultaneously co-developed, is increasingly adopted. In the case of the co-design, different exclusive simulators are respectively used for verifying the hardware and software. Besides, a simulator for verifying the entire system is further necessary. In the respective simulators are assumed functional models described in different levels of abstraction, which are the functional models respectively for processor, bus and hardware.

The problem is that the more complex and large-scaled the system LSI is, the more steps of preparing the functional models are required. As a result, all the benefits gained in the co-design may possibly be ruined because of the increased processing steps balancing out or even outstripping the benefits.

### SUMMARY OF THE INVENTION

Therefore, a main object of the present invention is to provide a simulation technology capable of standardizing functional models for simulators for various uses. Other objects, aspects and advantages of the present invention will become apparent from the following description of the invention.

The simulator apparatus according to the present invention comprises:

a simulator model including a functional model for CPU constituting a system to be simulated;

a simulator model including a functional model for hardware connected to a bus linked to the CPU;

plural types of interfaces included in the simulator models enabling plural types of the simulators for different uses to access the functional models; and

a simulator controlling device for selecting any of the plural types of the interfaces and accessing the respective functional models via the selected interfaces.

According to the foregoing configuration, the plural types of the interfaces include an interface usable in a simulator for verifying hardware, an interface usable in a simulator for verifying software, an interface usable in a simulator for verifying a system, and the like.

The foregoing configuration comprises the functional model for the CPU and the functional model for the hardware such as peripheral circuits and the like with the interfaces for various uses interposed therebetween. Therefore, the foregoing configuration can standardize the functional models for the different uses such as the hardware verification, software verification and system verification and the like.

More specifically, common functional models can be utilized in the various-use simulators in a large-scaled system LSI, such as the simulator for verifying the hardware, simulator for verifying the software, simulator for verifying the system, and the like. The different simulators share the common functional models so that the integrated simulation control enables the simulation to be implemented at a suitable precision. As a result, it becomes unnecessary to provide the functional models separately for the different uses.

The interfaces for the respective functional models also include an interface usable in debugging. The simulation can be effectively implemented by means of the interface usable in the debugging, an example of which is an interface for breaking (discontinuation of processing), as a blocking feature, used when data transfer is commenced and terminated. In that case, the functional models for the different uses can be commonly used to thereby improve the performance of the debugging.

The interfaces for the respective functional models further include an interface capable of simulating clock cycles of the system. The interface is effective when the respective functional models are driven at timings of clock level and suitable for the simulator for verifying the hardware.

Moreover, in the foregoing configuration of the simulator apparatus, the interfaces for the respective functional models further include an interface capable of simulating a simulation time for the system, which is effective when the respective functional models employ different clock cycles. This realizes a simulation environment in which the functional models adopting different clock sources can be provided.

In the foregoing configuration of the simulator apparatus, the interfaces for the respective functional models further include an interface for extension usable in performance analysis. An optimum system can be accordingly designed by having the system tuned based on the result of the performance analysis. The foregoing and other aspects will become apparent from the following description of the present invention when considered in conjunction with the accompanying drawing figures.

### BRIEF DESCRIPTION OF THE DRAWINGS

FIG. 1 is a block diagram illustrating the configuration of a simulator apparatus according to a preferred embodiment of the present invention.

FIG. 2 is a schematic diagram illustrating a system LSI.

FIG. 3 is a schematic diagram illustrating a simulator for verifying hardware.

FIG. 4 is a schematic diagram illustrating a simulator for verifying software.

FIG. 5 is a schematic diagram illustrating a simulator for verifying a system.

FIG. 6 is a schematic diagram illustrating precision required in a simulator for verifying hardware.

FIG. 7 is a schematic diagram illustrating precision required in a simulator for verifying software.

FIG. 8 is a schematic diagram illustrating precision required in a simulator for verifying a system.

FIG. 9 is a schematic diagram illustrating an interface for a simulator for verifying software.

FIG. 10 is a flow chart showing processing steps of a conventional simulator for verifying software.

FIG. 11 is a flow chart showing processing steps of a simulator for verifying a system.

FIG. 12 is a diagram describing a difference between instruction level and cycle level.

FIG. 13 is a flow chart showing processing steps at instruction level,

FIG. 14 is a flow chart showing processing steps of an instruction 1 at instruction level.

FIG. 15 is a flow chart showing processing steps of an instruction 2 at instruction level.

FIG. 16 is a flow chart showing processing steps of an instruction 3 at instruction level.

FIG. 17 is a flow chart showing processing steps at cycle level.

FIG. 18 is a flow chart showing processing steps of a simulator for verifying hardware.

FIG. 19 is a block diagram illustrating the configuration of a simulator apparatus according to another preferred embodiment of the present invention.

In all these figures, like components are indicated by the same numerals

### DETAILED DESCRIPTION

Hereinafter, preferred embodiments of the present invention are described referring to the drawings.

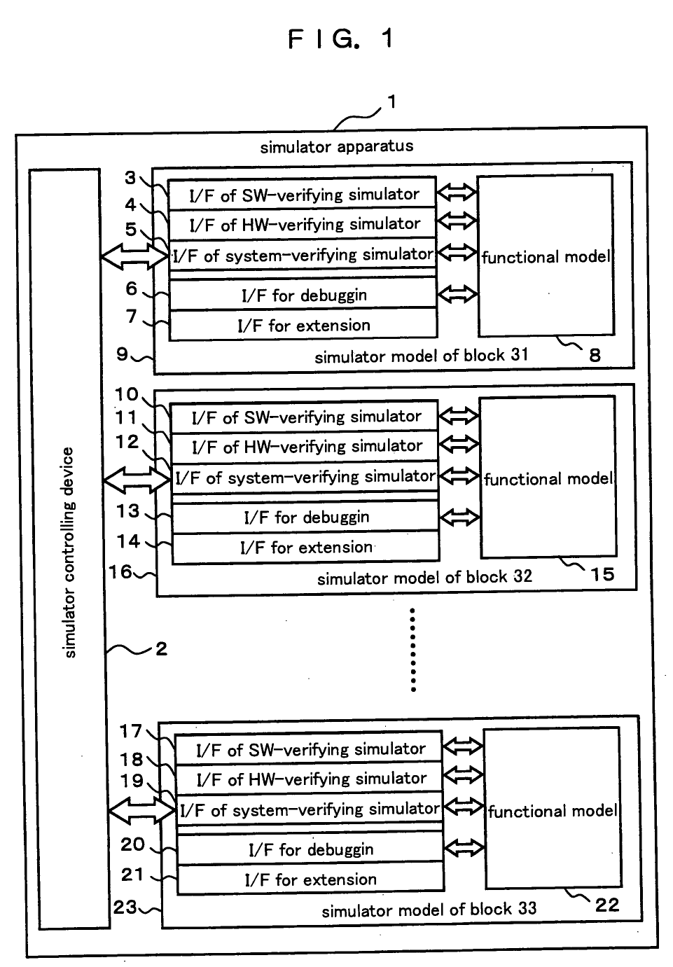

In a simulator apparatus 1 shown in FIG. 1, a system comprised of blocks 31, 32 and 33 is a simulation object. The simulator apparatus 1 is comprised of a simulator model 9 including a functional model 8 of the block 31, a simulator model 16 including a functional model 15 of the block 32, and a simulator model 23 including a functional model 22 of the block 33. For example, the block 31 is CPU and the blocks 32 and 33 are peripheral hardware.

The simulator model 9 comprises an interface 3 for a simulator for verifying software, an interface 4 for a simulator for verifying hardware, an interface 5 for a simulator for verifying a system, an interface 6 for debugging, and an interface 7 for extension.

The simulator model 16, likewise, comprises an interface 10 for the simulator for verifying the software, an interface 11 for the simulator for verifying the hardware, an interface 12 for the simulator for verifying the system, an interface 13 for debugging, and an interface 14 for extension.

The simulator model 23, likewise, comprises an interface 17 for the simulator for verifying the software, an interface 18 for the simulator for verifying the hardware, an interface 19 for the simulator for verifying the system, an interface 20 for debugging, and an interface 21 for extension.

When the simulator apparatus 1 is used to verify the hardware, a simulator controlling device 2 verifies the hardware. The simulator controlling device 2 controls the simulation for verifying the hardware by means of the respective interfaces 4, 11 and 18, which are used for the hardware-verifying simulator, of the simulator models 9, 16 and 23.

When the simulator apparatus 1 is used to verify the software, the simulator controlling device 2 verifies the software. The simulator controlling device 2 controls the simulation for verifying the software by means of the respective interfaces 3, 10 and 17, which are used for the software-verifying simulator, of the simulator models 9, 16 and 23.

When the simulator apparatus 1 is used to verify the system, the simulator controlling device 2 verifies the system. The simulator controlling device 2 controls the simulation for verifying the software by means of the respective interfaces 5, 12 and 19, which are used for the system-verifying simulator, of the simulator models 9, 16 and 23.

It is necessary to know the inside state of the apparatus such as register values of the blocks when the respective verifications are exercised. In that case, the inside state is retrieved by means of the interfaces 6, 13 and 20 for debugging to be utilized for the debugging. Any information required for the debugging, including values of signals other than the registers, is mounted in the apparatus by means of these interfaces.

Moreover, it is necessary to exercise the performance analysis based on the behavior of the system in the system-verifying simulator such as bus load in a multibus master system comprised of a plurality of bus masters, the utility rate of CPU in the case of the master being the CPU, a memory transfer rate and any data, the utility rate and the like of which is required. The respective models deliver data required for calculating the utility rate of the buses when the buses are demanded, when the utilization of the buses is permitted, when the utilization of the buses is relinquished, and the like, to an analysis system in the simulator controlling device and the like by means of the interface for extension.

The analysis system can be simply configured in such manner that the data is retained in the interfaces so as to be utilized for the analysis.

The functional capabilities of the blocks 31, 32 and 33 such as memorizing the content of the register are modeled in the functional models 8, 15 and 22. The functional capabilities are driven by means of the respective interfaces Accesses to the register and for the debugging are all mounted in the apparatus by means of the functional models. The foregoing mounting structure of the simulator apparatus eliminates the need to provide the functional models separately for different uses.

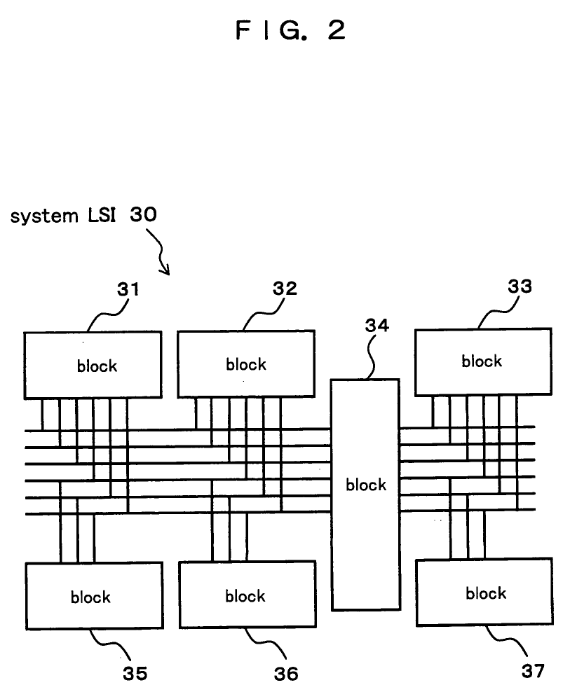

As shown in FIG. 2, a system LSI 30, which is a simulation object, is comprised of the blocks 31, 32, 33, 34, 35, 36 and 37 and the buses.

Hardware-Verifying Simulator

First is described the simulator for verifying the hardware.

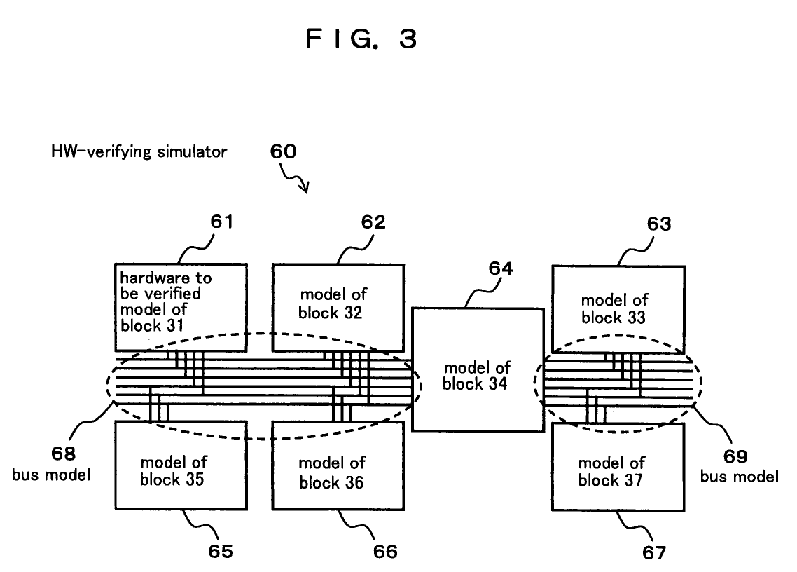

FIG. 3 illustrates an embodiment example of a simulator 60 for verifying hardware of the system LSI 30. The simulator 60 is comprised of functional models 61-67 for verification respectively corresponding to the blocks 31-37, which are the components of the system LSI 30, and bus models 68 and 69.

Here, the hardware to be verified is the block 31 and the functional model of the block 31 is the functional model 61. The functional models of the hardware include a description language called HDL (Hardware Description Language) or models designed in the high level synthesis. In this case, the respective functional models, which influence the blocks of the hardware to be verified, need to be accessed according to the clock cycles or RTL (Register Transfer Level).

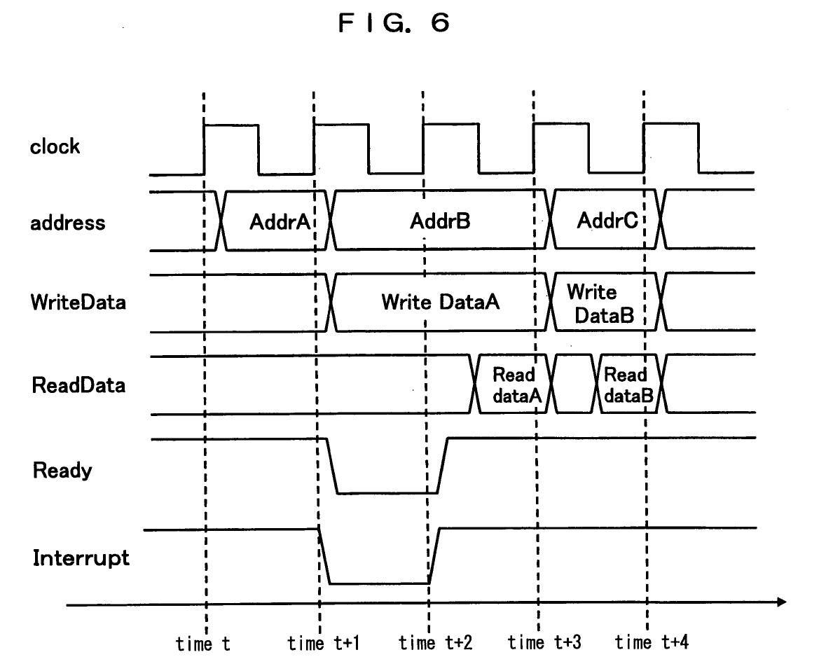

FIG. 6 shows precision required at clock level. It needs to be guaranteed that values of respective signals at times t, t+1, t+2, t+3 and t+4 are same as in an actual hardware descriptive model at pin level.

Software-Verifying Simulator

Next is described the simulator for verifying the software.

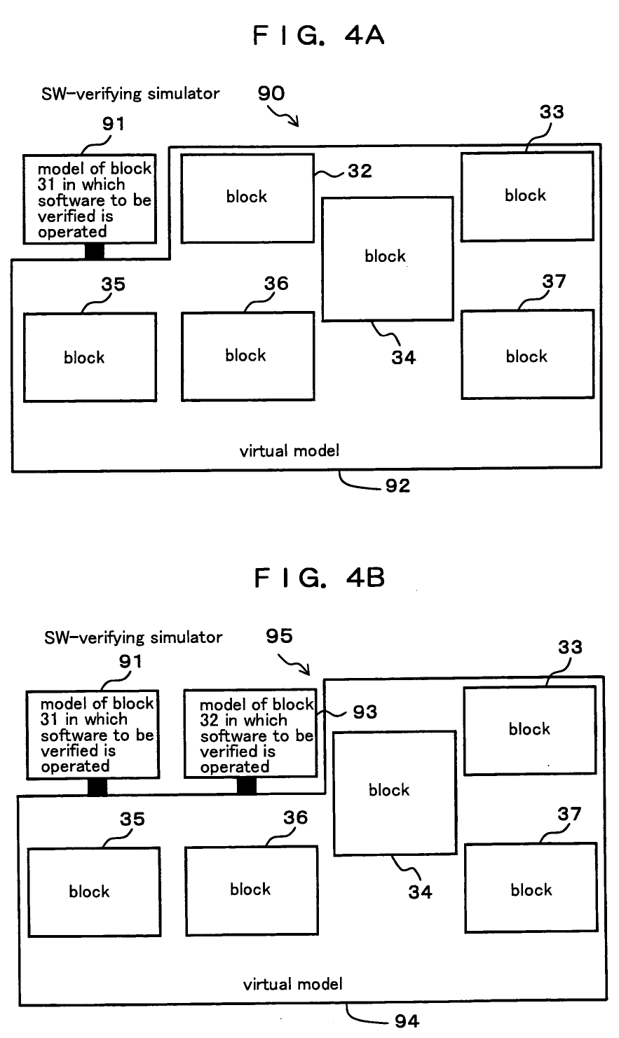

FIG. 4 shows an embodiment example of a simulator 90 for verifying software of the system LSI 30. Here, the software to be verified is operated in the block 31, and the functional model thereof is a model 91. Any component accessed by the software to be verified is mounted as a virtual model in the simulator 90, which is, in general, comprised of an instruction set simulator of the block 31 and a virtual model 92 including the blocks 32-37. The instruction set simulator guarantees precision at instruction level called ISS. In the virtual model 92 is mounted functional capabilities required for operating the software to be verified such as memory image and the like.

The software to be verified can possibly demand a high precision of a hardware model called middleware or device driver. In that case, precision close to the precision level of the hardware-verifying simulator of FIG. 3 can possibly be required of the virtual model. In the simulator fabricated for that purpose is often carried out such modeling that the model 91 controls the simulator and the virtual model 92 is used only in the case of accessing outside of the model 91. In some cases, the simulator may be a multiprocessor comprised of a plurality of processors, as shown in FIG. 4B.

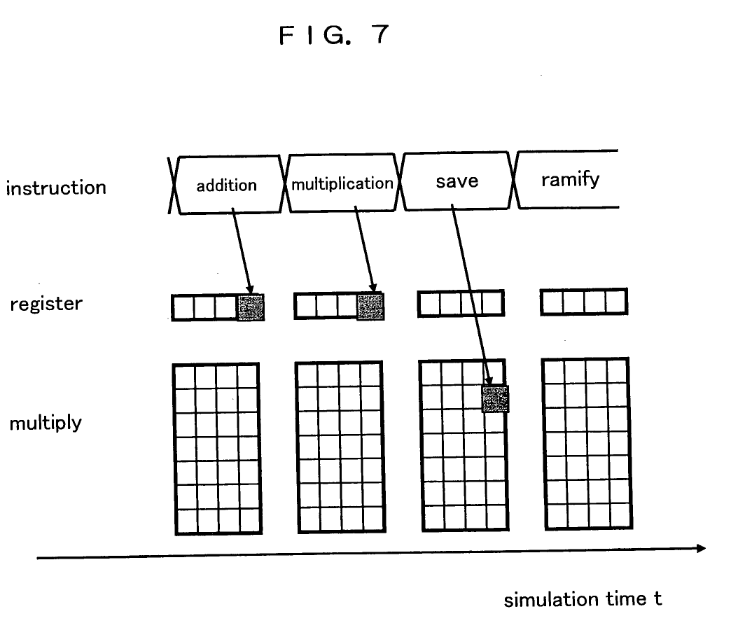

FIG. 7 shows precision required in verifying the software. The model 91 is the functional model of the block 31 in which the software-verifying software is operated. Here, it is indispensable for the respective instructions to influence the virtual model 92 outside of the model 91. The virtual model includes a register and memory.

System-Verifying Simulator

Next is described the simulator for verifying the system.

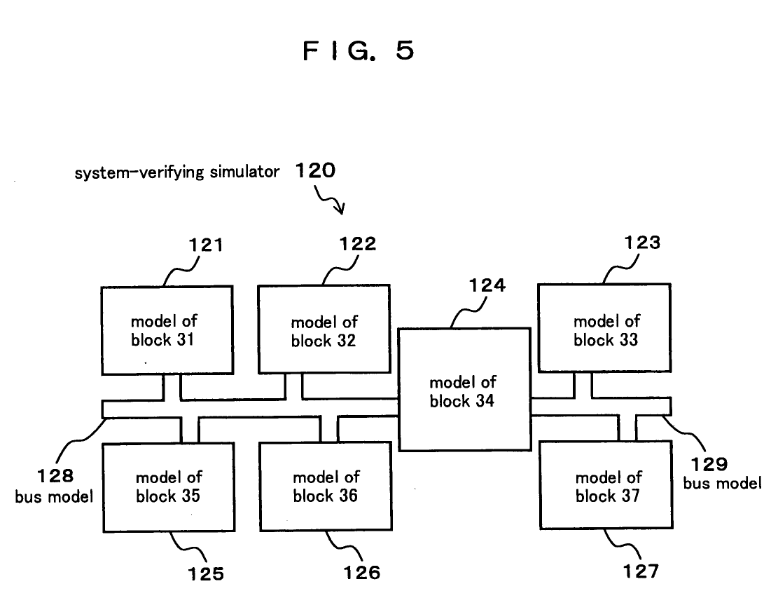

FIG. 5 shows an embodiment example of a simulator 120 for verifying a system of the system LSI 30. Any component accessed by the software operated in the system to be verified is mounted in the simulator 120. The simulator 120 is comprised of functional models 121-127 of the blocks 31-37 and bus models 128 and 129. In the respective functional models are mounted functional capabilities required for operating the system to be verified.

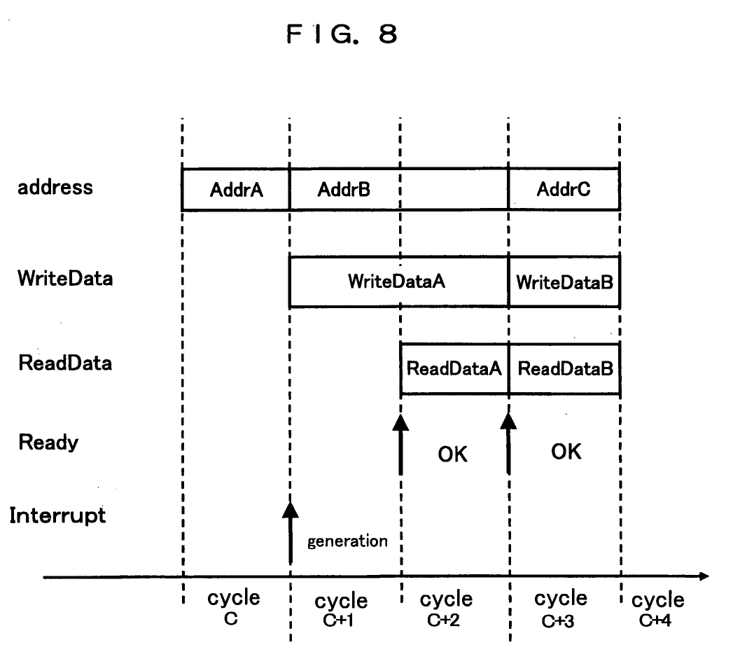

FIG. 8 is an example of precision required in verifying the system, which shows an intermediate level of precision between the precisions shown in FIG. 6 and FIG. 7. Models guaranteeing precision at respective cycles C, C+1, C+2, C+3 and C+4 are included. A simulator guaranteeing precision in transactions of higher abstraction is also included in the scope thereof.

Software-Verifying Interface

Next is described the interface 3 for the simulator for verifying the software.

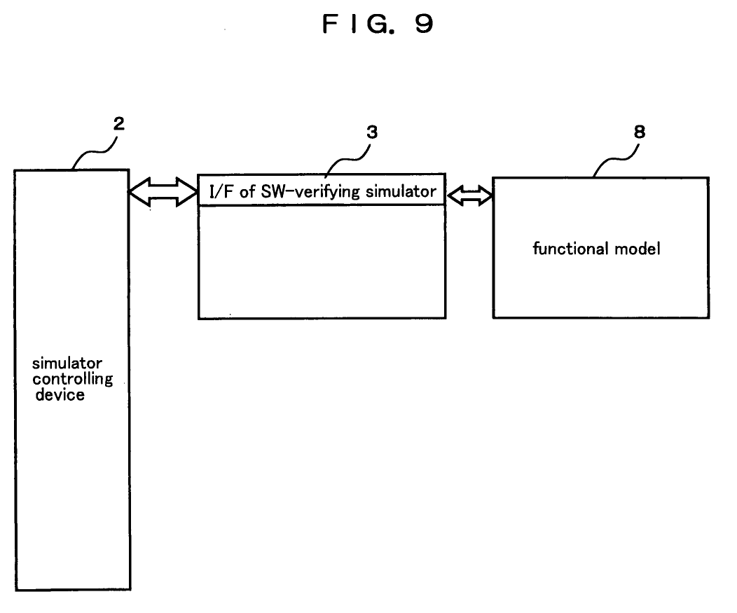

The interface 3 for the software-verifying simulator, which is shown in FIG. 9, may be prepared so that the software-verifying simulator is utilized as the system-verifying simulator.

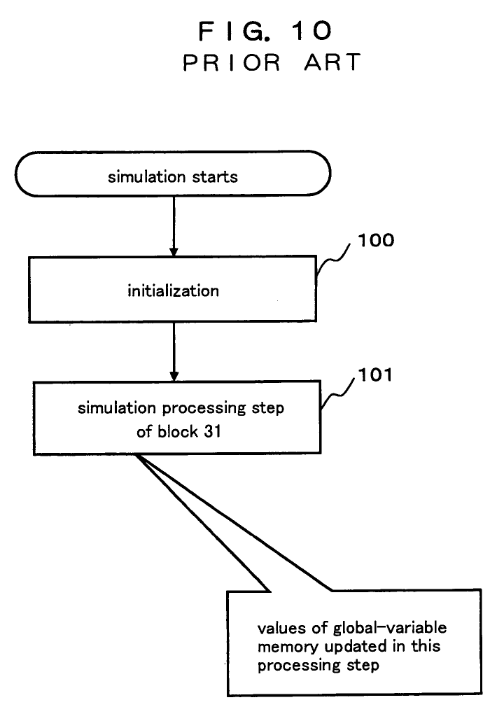

In the case of a conventional simulator for verifying software, only a processor, in which the software to be verified is operated, was modeled, while accesses to buses and memory were abstract. An example of the configuration is a processing shown in the flow chart of FIG. 10. An initializing step 100 is implemented, and a simulation processing with respect to the block 31 is subsequently implemented in a step 101. These processing steps include the implementation of processings with respect to the buses and memory. The configuration of the multiprocessor, as shown in FIG. 4B, is incapable of handling the foregoing processings.

Therefore, a function enabling callings by the simulator controlling device 2, is defined. In the case of exercising an influence outside when the function is implemented, accesses are made to the outside via the interface 3. Thus, software-verifying simulator can be utilized as the system-verifying simulator.

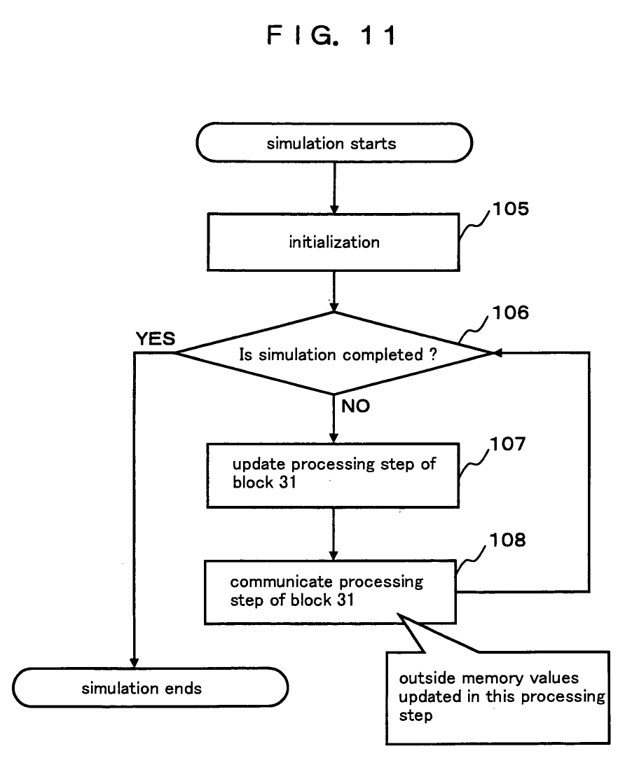

The foregoing processings are shown in the flow chart of FIG. 11. An initializing step 105 is implemented, and whether or not the simulation is completed is checked in a step 106. When it is checked that the simulation is completed, the simulation is terminated. When the simulation is not completed yet, values inside the functional model 8 of the block 31 are updated in a step 107. At that time, no processing exercising the influence to the buses and memory is implemented. A communication processing is implemented to outside of the functional model 8 in a next step 108 by making accesses via the interfaces of the involved blocks. The foregoing processing steps are mounted in the simulator controlling device 2.

As described, the interface 3 for the software-verifying simulator is mounted so that the software-verifying simulator can be utilized as the system-verifying simulator.

System-Verifying Interface

Next is described an interface 5 for the simulator for verifying the system.

The interface 3 for the software-verifying simulator described earlier is mounted at instruction level. In contrast to that, the interface 5 is mounted at cycle level.

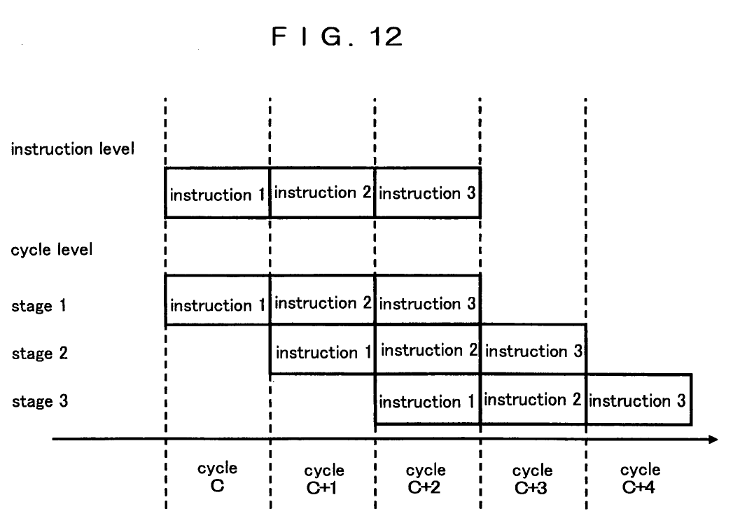

FIG. 12 shows a difference between the instruction level and cycle level. Here, the model 31 is comprised of three pipeline states.

At the instruction level, respective instructions are sequentially implemented.

At the cycle level, respective instructions run down the pipeline stages.

At a cycle C, an instruction 1 is processed in a stage 1. At a cycle C+1, the instruction 1 is processed in a stage 2, and an instruction 2 is processed in the stage 1.

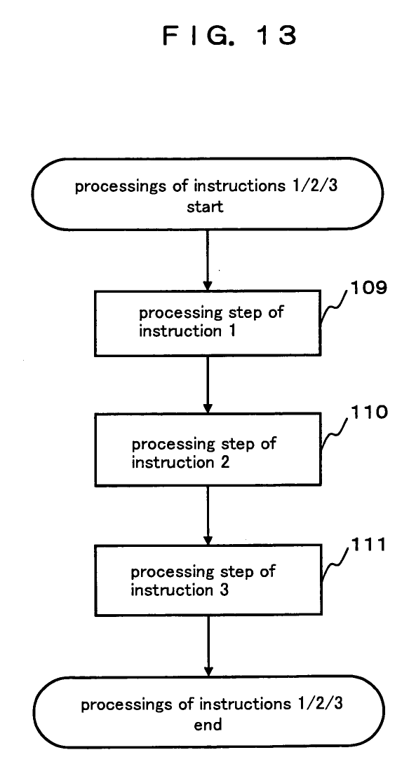

FIG. 13 is a flow chart showing processing steps at the instruction level. The processings at the instruction level are proceeded in the order of a processing step 109 of the instruction 1, a processing step 110 of the instruction 2, and a processing step 111 of an instruction 3.

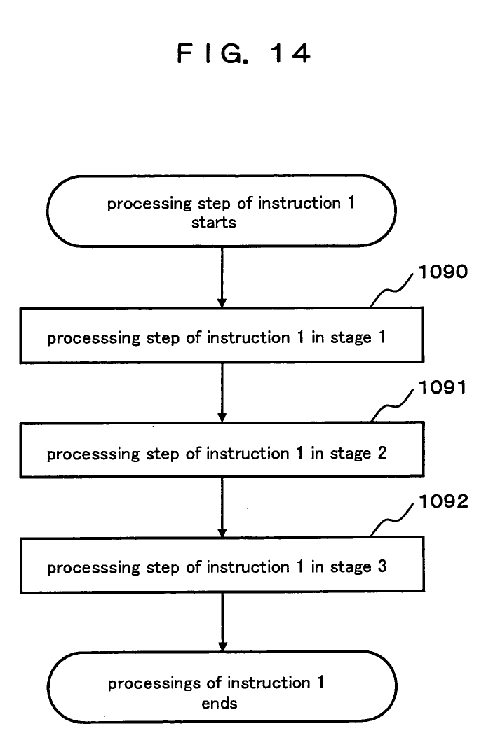

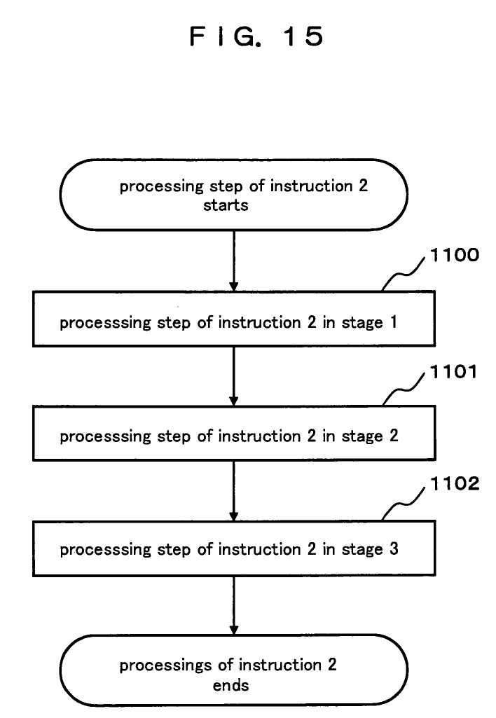

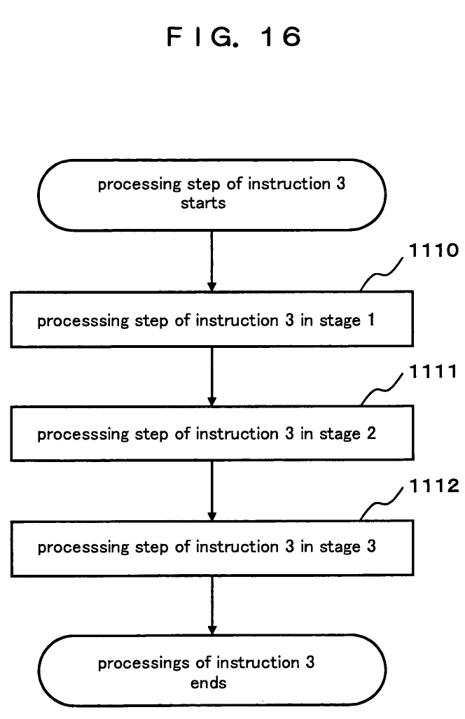

In the functional model 8, the processing step 109 of the instruction 1 shown in FIG. 13 is developed as in FIG. 14. The processing step 110 of the instruction 2 shown therein is developed as in FIG. 15. The processing step 111 of the instruction 1 shown therein is developed as in FIG. 16.

More specifically, in the case of the processing step 110 of the instruction 1, the simulator controlling device 2 exercises controlling in the order of a processing step 1090 in the stage 1, a processing step 1091 in the stage 2, and a processing step 1092 in the stage 3 as shown in FIG. 14.

Likewise, in the case of the processing step 110 of the instruction 2, the simulator controlling device 2, as shown in FIG. 15, exercises controlling in the order of a processing step 1100 in the stage 1, a processing step 1101 in the stage 2, and a processing step 1102 in the stage 3.

Further, in the case of the processing step 111 of the instruction 3, the simulator controlling device 2, as shown in FIG. 16, exercises controlling in the order of a processing step 1110 in the stage 1, a processing step 1111 in the stage 2, and a processing step 1112 in the stage 3.

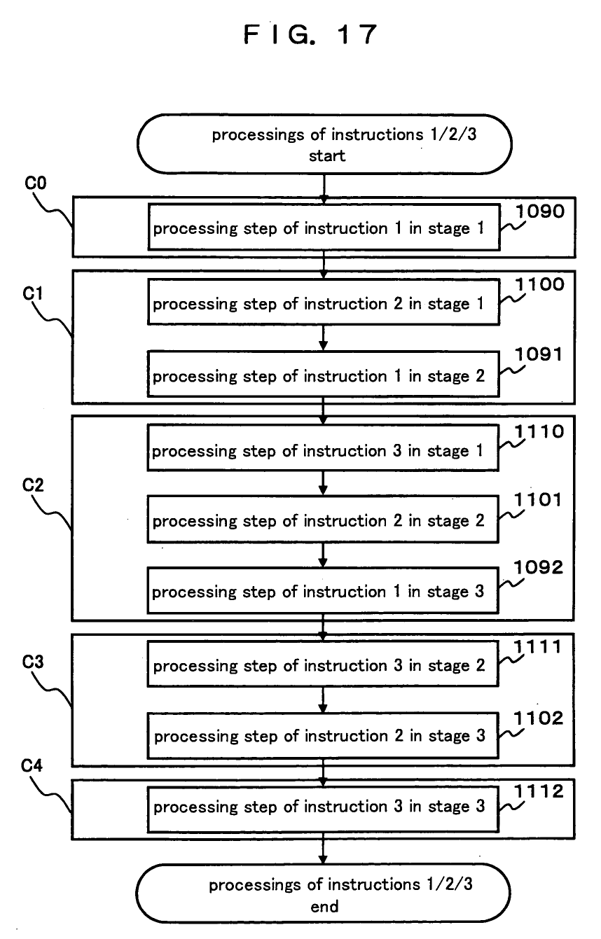

Meanwhile, at the cycle level in the case of the system-verifying interface, the foregoing processings are controlled as in the flow chart of FIG. 17, which correspond to the processings at the cycles C, C+1, C+2, C+3, and C+4 in FIG. 12.

In FIG. 17, C0 represents a processing at a cycle C (instruction 1, stage 1). C1 represents processings (instruction 2, stage 1) and (instruction 1, stage 2) at a cycle C+1. C2 represents processings (instruction 3, stage 1), (instruction 2, stage 2) and (instruction 1, stage 3) at a cycle C+2. C3 represents processings (instruction 3, stage 2) and (instruction 2, stage 3) at a cycle C+3. C4 represents a processing (instruction 3, stage 3) at a cycle C+4.

For example, in the step C2 are respectively implemented the processing step 1110 of the instruction 3 in the stage 1, the processing step 1101 of the instruction 2 in the stage 2, and the processing step 1092 of the instruction 1 in the stage 3. In what order the processing steps 1110, 1101 and 1092 are implemented relies on dependency relations among the stages. The effect of the present invention is still achievable when the processing steps are implemented not sequentially but simultaneously. Therefore, the simultaneous implementation is included in the scope of the present invention. As described, the effect of the present invention can be obtained by having the simulator controlling device 2 exercise controlling by means of the system-verifying interface 5.

Hardware-Verifying Interface

Next is described an interface 4 for the simulator for verifying the hardware. In verifying the hardware, an interface of the precision level shown in FIG. 6 is required. The interface 4 at least carries out the rise and fall of the clocks and receipt and delivery of such an event that signal values change at right timings. Thus, the simulator apparatus with the simulator controlling device 2 employed therein achieving precision shown in FIG. 8 can be realized.

The methods of mounting the precision shown in FIG. 8 and precision required in the hardware-verifying simulator are described below.

The processing steps shown in FIG. 17 include “update” and “communicate” shown in FIG. 11. The respective functional models are called per clock cycle by the simulator controlling device 2. The inside states of the functional models are updated according to an update function, and communication to outside is exercised by means of the communicate.

Here, the hardware-verifying simulator requires such timings that when the driving sides of signals drive the signals. In the system-verifying simulator, communicate is mounted at timings with respect to, not the driving sides of the signals, but driving sides of transactions (hereinafter referred to as master).

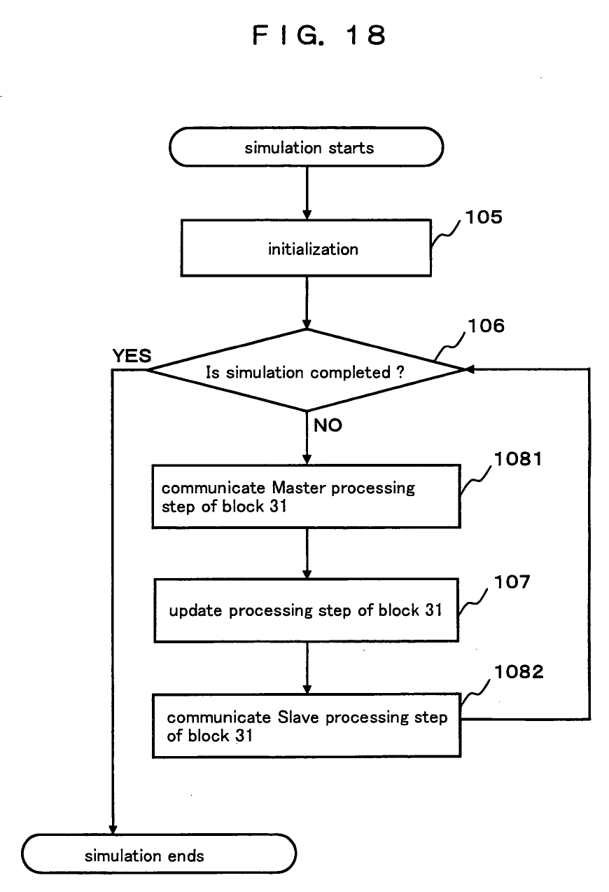

Then, as shown in the flow chart of FIG. 18, as an interface for the functional model 8, the communicate according to the master of the transactions is divided into a communicate Master processing step 1081 and a communicate Slave processing step 1082. The former mounts an interface for driving the signals, and the latter mounts an interface in connection with the driven signals.

The steps 107 and 108 shown in FIG. 11 are called per each of the cycles C, C+1, C+2, C+3 and C+4 of FIG. 12. The steps 1081, 107 and 1082 shown in FIG. 18 are called by the simulator controlling device 2.

In the communication of the step 108, the communication master of the step 1081 and the communication slave of the step 1082 may be consecutively called, otherwise the functional model 8 may provide functional capabilities equivalent to those of the steps 1081 and 1082.

As described, by employing the method according to the present invention, the models are standardized in the verifications of the software, system and hardware. According to this embodiment, an easy-to-comprehend example is described as the abstraction for verifying the software, system and hardware, however the present invention includes different levels of abstraction for the respective verifications.

Debugging Interface

Next is described an interface for debugging.

As an example of the interface for debugging, the case of DMA block being a covering object is exemplified. The DMA is a block in which the functional capability of memory data transfer is mounted. More specifically, the DMA comprises an interface for implementing breaking, as a blocking feature, (discontinuation of processing) when such processings as the commencement and termination of the data transfer are implemented. This improves the performance of the debugging.

This interface can be commonly utilized in the functional models for the respective uses. Further, values of the memory possessed by the block including a memory mapped IO register may be occasionally referenced in the debugging. An interface for referencing and changing the memory values and the like is included in the interface for the debugging. In the respective verifications, the behavior of the buses is sometimes unnecessary while only the memory values are to be rewritten. In that case, the simulation can be exercised at a higher speed by using the interface.

The following development is an option. In order to further accelerate processings in the software development, the memory feature can be mounted, not in a block for retaining the memory, but in a block in charge of supervising the entire memory. In that case, the configuration is arranged in such manner that only the software-operated block and memory block can be controlled by the simulator controlling device, while other blocks are separated. In this manner, the simulation is implemented at even a higher speed, which is also included in the scope of the present invention.

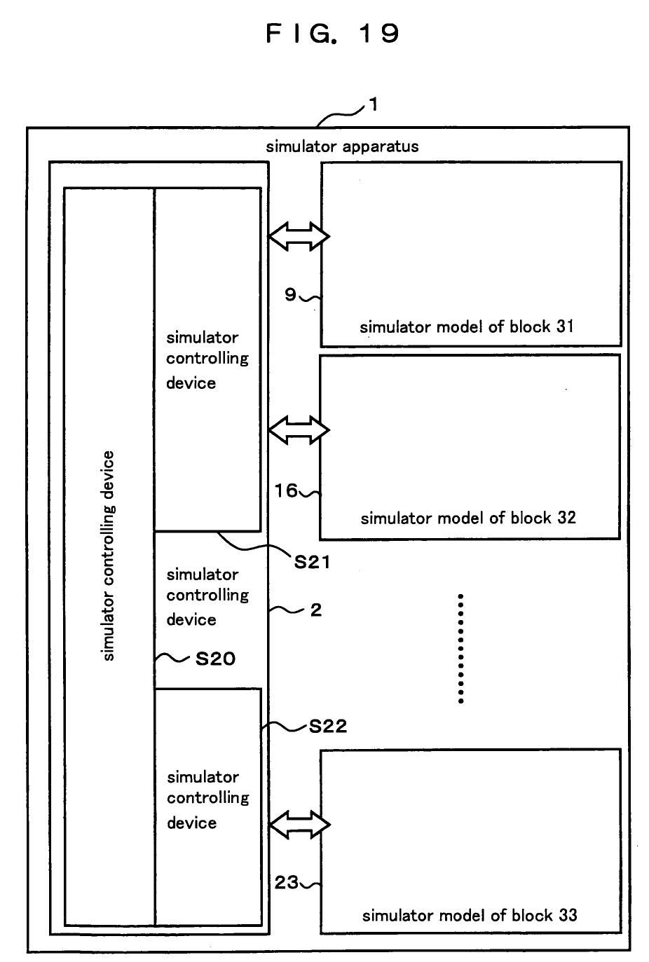

In the description so far, one simulator controlling device 2 is mounted. However, a plurality of controlling devices can be mounted in actual uses. FIG. 19 shows an example, in which the controlling device 2 is comprised of three simulator controlling devices S20, S21 and S22.

The simulator controlling device S20 controls the simulator controlling devices S21 and S22. The simulator controlling device S21 controls the simulator models 9 and 16. The simulator controlling device S22 controls the simulator model 23.

Here is described the case in which the clock cycles used in the simulator models 9 and 16 and the clock cycles used in the simulator model 23 are different to each other. In that case, it is necessary for the controlling devices S21 and S22 to exercise controlling based, not on the number of the respective clock cycles, but on the simulation time. The mounting of the foregoing functional capability realizes a simulation environment in which models using the different clock sources can be provided.

Extension Interface

Finally, a performance analysis, as an example of an interface for extension, is described below.

In the system verification, the performance analysis is exercised by means of various information such as which bus masters to what extent utilize and occupy the buses, when and to which memory addresses accesses are made, how much time is required before the buses are used, and the like. The interface for extension is used in order to obtain such information. The performance analysis is exercised based on the information, and the system is retuned based on the result of the performance analysis to thereby design an optimum system.

As described, according to the present invention, the common models can be utilized for the simulators for various uses such as the hardware-verifying simulator, software-verifying simulator and system-verifying simulator in the large-scale system LSI.

Therefore, the models can be standardized for the different simulators to thereby implement the simulation at a suitable precision by means of the integrated simulation control. This results in the reduction of steps of building an environment for co-designing the hardware and software in the large-scale system LSI. Thereby, the time period required for designing the system LSI is eventually shortened providing the system LSI of a higher performance and lower cost.

From the foregoing description, it will be apparent what the present invention provides.

What is claimed is:

1. A simulator apparatus comprising:
a simulator model including a functional model for CPU constituting a system to be simulated;
a simulator model including a functional model for hardware to be connected to buses linked to the CPU;
plural types of interfaces included in the simulator models and enabling plural types of simulators for various uses to access to the functional models; and
a simulator controlling device for selecting any of the plural types of the interfaces and accessing the respective functional models via the selected interfaces.

2. A simulator apparatus as claimed in claim 1, wherein
the interfaces for the respective functional models comprise an interface usable in a simulator for verifying software.

3. A simulator apparatus as claimed in claim 1, wherein
the interfaces for the respective functional models comprise an interface usable in a simulator for verifying hardware.

4. A simulator apparatus as claimed in claim 1, wherein
the interfaces for the respective functional models comprise an interface usable in a simulator for verifying a system.

5. A simulator apparatus as claimed in claim 1, wherein
the interfaces for the respective functional models comprise an interface usable in debugging.

6. A simulator apparatus as claimed in claim 1, wherein
an interface capable of simulating clock cycles of the system as precision at processing level is comprised.

7. A simulator apparatus as claimed in claim 1, wherein
an interface capable of simulating a simulation time for the system as precision at processing level is comprised.

8. A simulator apparatus as claimed in claim 1, wherein
the interfaces for the respective functional models comprise an interface for extension usable in performance analysis.
